(19) United States
(12) Patent Application Publication
(10) Pub. No.: US 2014/0042063 A1
(43) Pub. Date: Feb. 13, 2014

(54) Debris-Capturing Apparatus for Cleaner

(71) Applicant: Dieter J. Rief, Santa Rosa, CA (US)

(72) Inventor: Dieter J. Rief, Santa Rosa, CA (US)

(73) Assignee: POOLVERGNUEGEN, Santa Rosa, CA (US)

(21) Appl. No.: 13/568,838

(22) Filed: Aug. 7, 2012

(51) Int. Cl. C02F 1/00

(52) U.S. Cl. 210/167.17

(57) ABSTRACT

A debris-capturing apparatus for a cleaner device having an outflow port through which debris-laden liquid flows. The debris-capturing apparatus has an entry annulus and a debris cavity to receive flow of debris-laden liquid. A collapsible elongate back-flow restrictor, which is substantially erect in the flow direction during inflow, has an annular proximal-end portion secured about the entry annulus and a free-end portion within the debris cavity. The free-end portion has at least one discontinuity along the length thereof to relieve resistance to debris-laden fluid flow into the cavity and to facilitate collapse of the restrictor for back-flow restriction.

### FIELD OF THE INVENTION

The present invention relates to swimming pool cleaners and, more particularly, to automatic cleaners that move along the underwater surface of a swimming pool. Still more specifically, the invention relates to devices designed to collect and capture the debris dislodged during the sweep of a pool through the operation of such cleaners.

### BACKGROUND OF THE INVENTION

Automatic swimming pool cleaners of the type that move or sweep along the underwater surface of a residential or commercial swimming pool have become popular for dislodging and collecting debris and sediment from the floor of the pool. Pool cleaners of this type include several in which a flow of water under pressure is harnessed to provide power for the forward motion of the cleaners, and also include means by which debris-laden water is drawn in some manner into debris-capturing apparatus. See, for example, the turbine-driven automatic swimming pool pressure cleaner shown and described in commonly-owned PCT International Publication No. WO 01/92663 (Rief et al.), entitled “Swimming Pool Pressure Cleaner with Internal Steering Mechanism,” of Poolvergnuegen of Santa Rosa, Calif. An example of a suction cleaner can be seen in U.S. Pat. No. 6,854,148 (Rief et al.). Typically, the pressurized water supply or the suction for such automatic pool cleaners are provided by a remote pump.

A typical debris-capturing apparatus for such devices is referred to as a pressure-cleaner bag. Such bags are made from a flexible porous fabric that allows water drawn upward from the floor of the pool into the bag to pass through it, thus trapping any and all debris entering the bag with the water. Moreover, each of these bags has an attachment portion that forms an opening into the bag and provides sleeved attachment to an outflow port of the pool cleaner. An example of such typical bag is disclosed in U.S. Pat. No. 6,908,550.

In many cleaner bags, however, debris will tend to collect inside the bag in the area of the attachment to the outflow port. This poses a number of problems to the effective operation of the cleaner. The accumulation of debris near the mouth of the outflow port creates an obstruction to the free flow of water through the port. It also allows the debris to re-enter the swimming pool by falling back through the outflow port when the cleaner is turned off. In addition, some spillage of debris is inevitable when the bag is removed from the cleaner due to the absence of any means of closing off the opening into the bag.

While some improvements have been made in the past in pressure-cleaner bags to address certain of these concerns, past efforts have involved certain other disadvantages. For example, certain prior devices have involved complex designs that may add expense in the manufacture of pressure-cleaner bags, limit the ability for efficient reuse over time, and even somewhat restrict or limit the inflow of water and debris. One such prior device is disclosed in U.S. Pat. No. 4,856,913 (Campbell).

U.S. Pat. No 6,706,175 (Rief et al.), the entire contents of which are incorporated herein by reference, discloses a debris-capturing bag which is an example of debris-capturing apparatus in such pool cleaners. FIG. 1, which is taken from the '175 patent and is marked “Prior Art,” shows a debris-capturing bag 17 which defines a debris-capturing cavity and includes an inflow tube 40 secured at an outflow port 12. Such inflow tube is substantially erect along the flow axis when water is flowing into the bag, but when flow ends tube 40 collapses axially so as to block any reverse flow of debris out of the cavity. In other words, when the cleaner is not operational the absence of the inflow of water causes the tube to collapse on itself inside the bag. More specifically, the inflow tube folds over onto itself to form a flaccid mound of material in a random fashion covering the outflow port (which is the inflow port with respect to the bag) and thereby blocking any flow of debris out of the bag. This collapse, because it is along the axis of what was the erect inflow tube and is generally in the direction of the proximal end of such tube, can be described as “axial collapse.”

While the inflow tube provides a solution for minimizing spillage of debris back into the swimming pool (through the body of the pool cleaner), the inflow tube also tends to create a resistance to the incoming flow of debris-laden water, despite the fact that the water causes the inflow tube to expand laterally, as shown in FIG. 7 (another “Prior Art” illustration). Also, collection of excessive debris on the inflow tube itself tends to hamper its collapse and the back-flow-blocking action. Therefore, further improvements would be beneficial for increased efficiency of the cleaner. This invention is directed to such improvements.

### SUMMARY OF THE INVENTION

This invention is an improvement in a debris-capturing apparatus for a cleaner device having an outflow port through which debris-laden fluid flows. The debris-capturing apparatus has an entry annulus and a debris cavity to receive flow of debris-laden fluid. A collapsible elongate back-flow restrictor, which is substantially erect in the flow direction during inflow, has an annular proximal-end portion secured about the entry annulus and a free-end portion within the debris cavity. The free-end portion has at least one discontinuity along the length thereof to relieve resistance to debris-laden fluid flow into the cavity and to facilitate collapse of the restrictor for back-flow restriction.

In some embodiments, the debris cavity is defined by a wall of a fluid-pervious material. The entry annulus may be configured for securement to the outflow port.

The free-end portion may include a plurality of discontinuities. In such embodiments, the free-end portion may be formed by a plurality of strips extending from the proximal-end portion to free ends, the strips being separated from one another when the restrictor is substantially erect. In some embodiments, the free-end portion includes two discontinuities and is formed by two strips.

In certain embodiments, the proximal-end portion is substantially free of discontinuities. In such embodiments, the free-end portion is greater than half the length of the restrictor. The free-end portion may be greater than about two-thirds the length of the restrictor.

The restrictor may be a single piece with the proximal-end portion and the free-end portion being integrally formed. In some embodiments, the restrictor is formed by a slit tube. Such tube may be of a fluid-pervious material.

### BRIEF DESCRIPTION OF THE DRAWINGS

FIG. 1 is a perspective view showing a prior swimming pool pressure-cleaner bag mounted on a swimming pool pressure cleaner, including a partial cut-out showing internal bag components.

FIG. 2 is a side view of the swimming pool pressure-cleaner debris-capturing bag according to the present invention, including a partial cut-out showing a back-flow restrictor in a collapsed state prior to the cleaner being operational.

FIG. 3 is a side view of an embodiment of the swimming pool pressure-cleaner debris-capturing bag including a partial cut-out showing the back-flow restrictor state when fluid pressure is present at the outflow port during the cleaner operation.

FIG. 4 is a side view of the swimming pool pressure-cleaner debris-capturing bag including a partial cut-out showing the back-flow restrictor state immediately after stopping fluid pressure entering the bag from the outflow port.

FIG. 5 is a side view of the swimming pool pressure-cleaner bag of FIG. 4 including a partial cut-out showing the back-flow restrictor state minutes after stopping fluid pressure entering the bag from the outflow port.

FIG. 6 is a side view of the debris-capturing apparatus showing the direction of the flow of liquid into a debris cavity.

FIG. 7 is a fragmentary sectional view across the flow direction illustrating the back-flow restrictor in the prior swimming pool pressure-cleaner bag seen in FIG. 1.

FIG. 8 is a fragmentary sectional view across the flow direction illustrating the back-flow restrictor according to the present invention.

FIG. 9 is a side view of one example of the back-flow restrictor according to the present invention.

FIG. 10 is a side view of another example of the back-flow restrictor according to the present invention.

FIG. 11 is a side view of yet another example of the back-flow restrictor according to the present invention.

FIG. 12 is a side view of still another example of the back-flow restrictor according to the present invention.

FIG. 13 is a perspective view of a pressure-cleaner debris-capturing apparatus being a rigid canister and including a back-flow restrictor according to the present invention, the canister illustrated open to show the back-flow restrictor.

FIG. 14 is a perspective view of an in-line suction-cleaner debris-capturing apparatus including a back-flow restrictor according to the present invention.

FIG. 15 is a cross-sectional view of a swimming pool showing a suction cleaner with the in-line debris-capturing apparatus of FIG. 14.

FIG. 16 is a perspective view of a suction-cleaner debris-capturing apparatus being a rigid canister and including a back-flow restrictor according to the present invention.

### DETAILED DESCRIPTION OF PREFERRED EMBODIMENTS

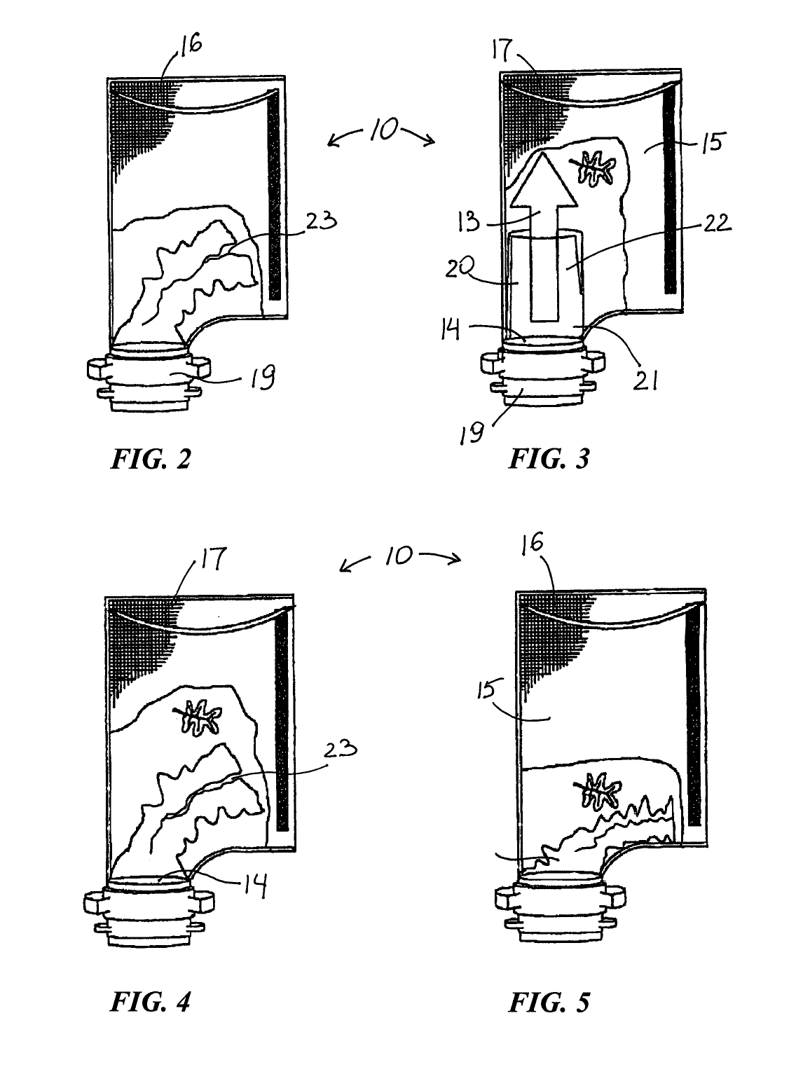

FIGS. 2-6 and 8-16 illustrate an improvement in a debris-capturing apparatus 10 for a cleaner device 11 with an outflow port 12 through which debris-laden fluid 13 flows. FIGS. 2-6, 13 and 14 show debris-capturing apparatus 10 having an entry annulus 14 and a debris cavity 15 to receive flow of debris-laden fluid 13. A collapsible elongate back-flow restrictor 20, which is substantially erect in the flow direction during inflow, as illustrated in FIGS. 3, 6 and 8-12, has an annular proximal-end portion 21 secured about entry annulus 14 and free-end portion 22 within debris cavity 15. Free-end portion 22 has at least one discontinuity 23 along the length thereof to relieve resistance to debris-laden fluid flow 13 into cavity 15, as seen in FIG. 8, and to facilitate collapse of restrictor 20 for back-flow restriction illustrated in FIGS. 4 and 5.

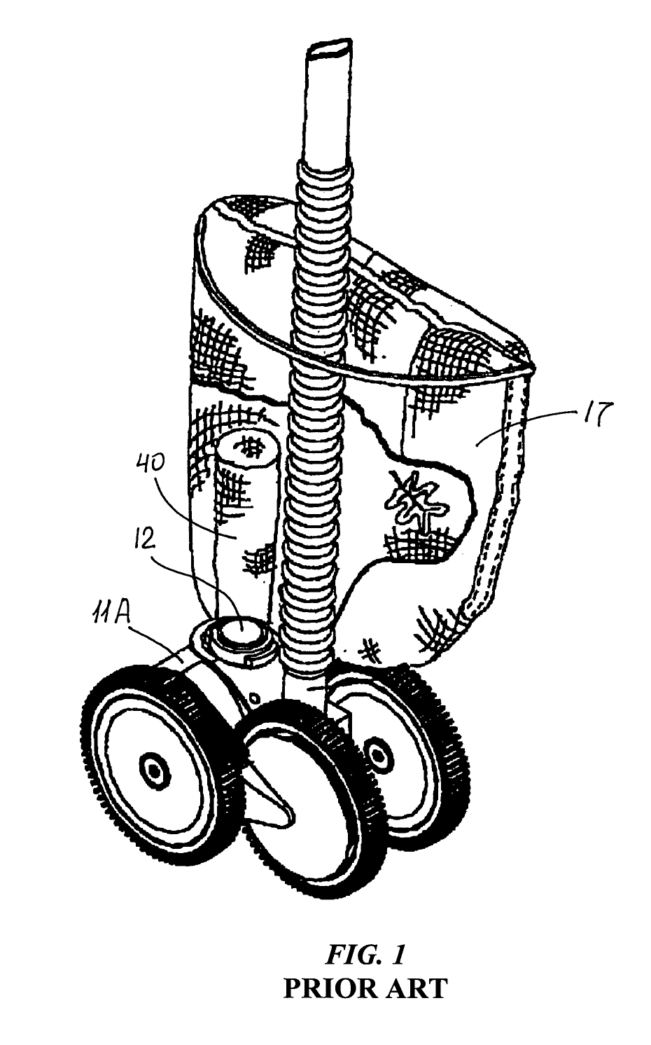

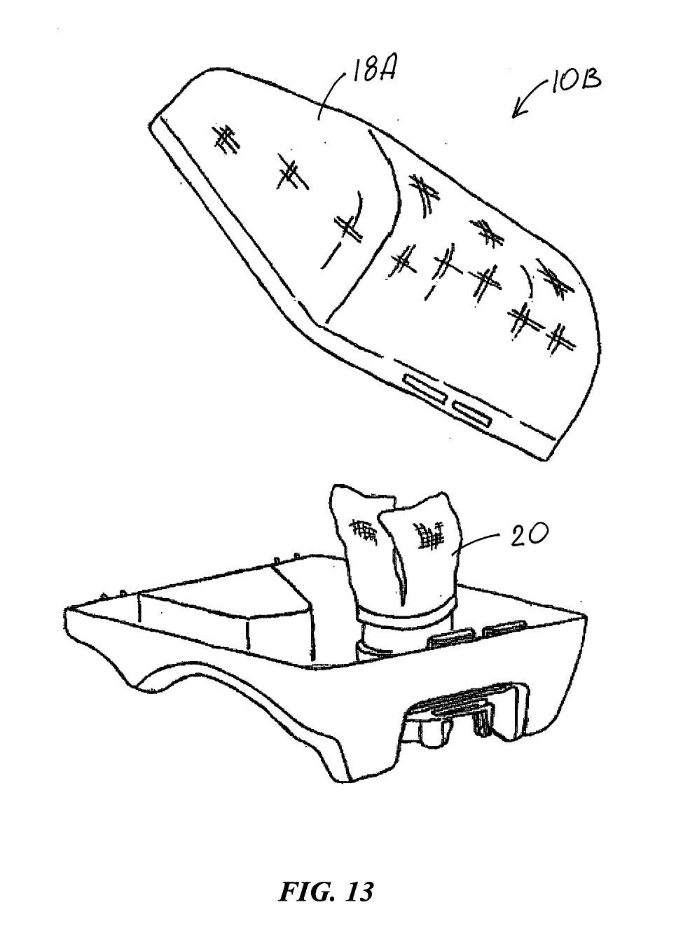

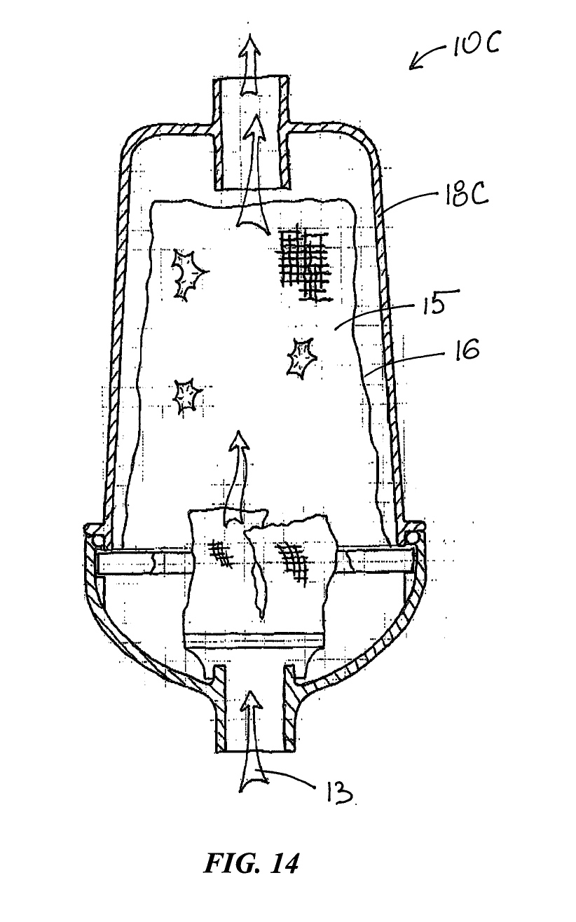

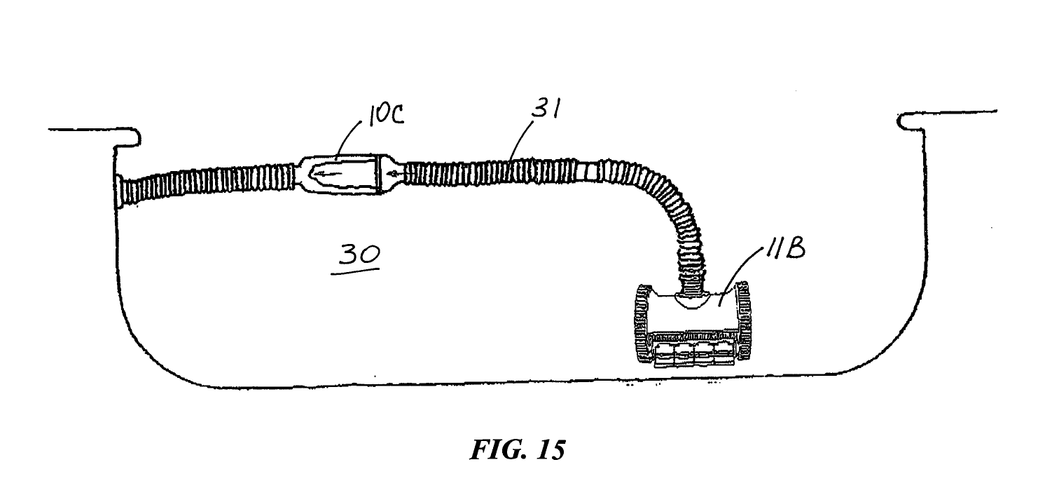

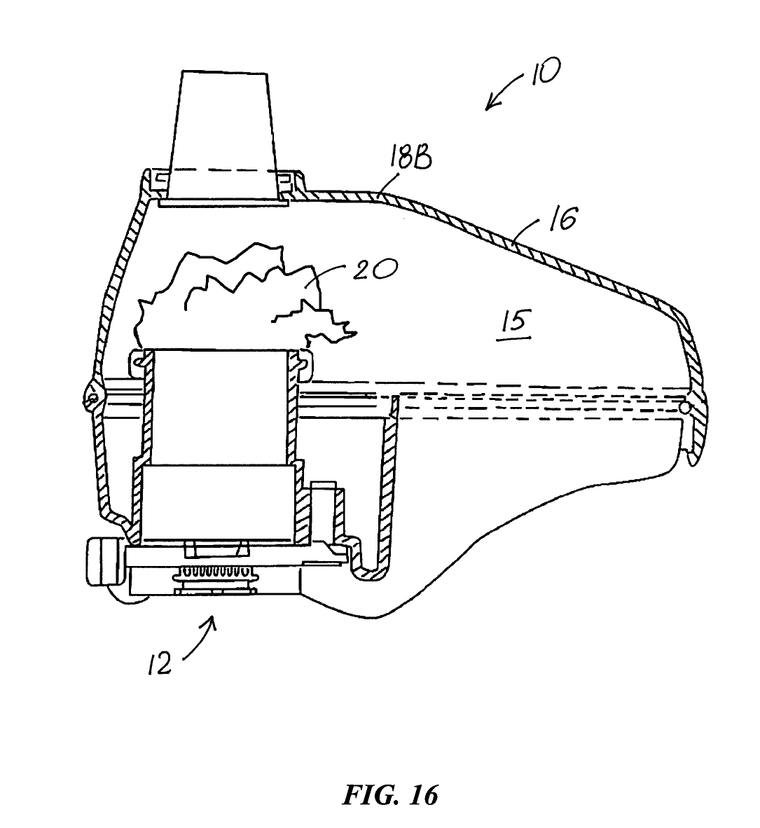

Debris cavity 15 is defined by a wall 16 of a fluid-pervious material. FIGS. 2-6 show debris-capturing apparatus 10A in the form of a flexible bag 17 for use with pressure cleaner 11A seen in FIG. 1. FIG. 13 shows debris-capturing apparatus 10B in the form of a rigid canister 18A for use with pressure cleaner 11A. FIG. 16 shows that rigid debris canister 18B may also be used with suction cleaner 11, as described in co-owned Patent Application Publication No. 2012/0074050, entire contents of which are incorporated herein by reference. FIG. 14 shows debris-capturing apparatus 10C including a rigid canister 18C for an in-line use with suction cleaner 11B, as shown in FIG. 15. FIG. 15 schematically illustrates suction cleaner 11B in a swimming pool 30 with a suction hose 31 connected to a pump and including in-line debris-capturing apparatus 10C. As seen in FIG. 14, debris-capturing apparatus 10 may be formed by a combination of a flexible bag placed inside rigid canister 18 to maximize capturing of debris and maintain efficiency of cleaner 11.

FIGS. 2-6 show debris-capturing apparatus 10A including an attachment arrangement 19 for securing entry annulus 14 of bag 17 to outflow port 12.

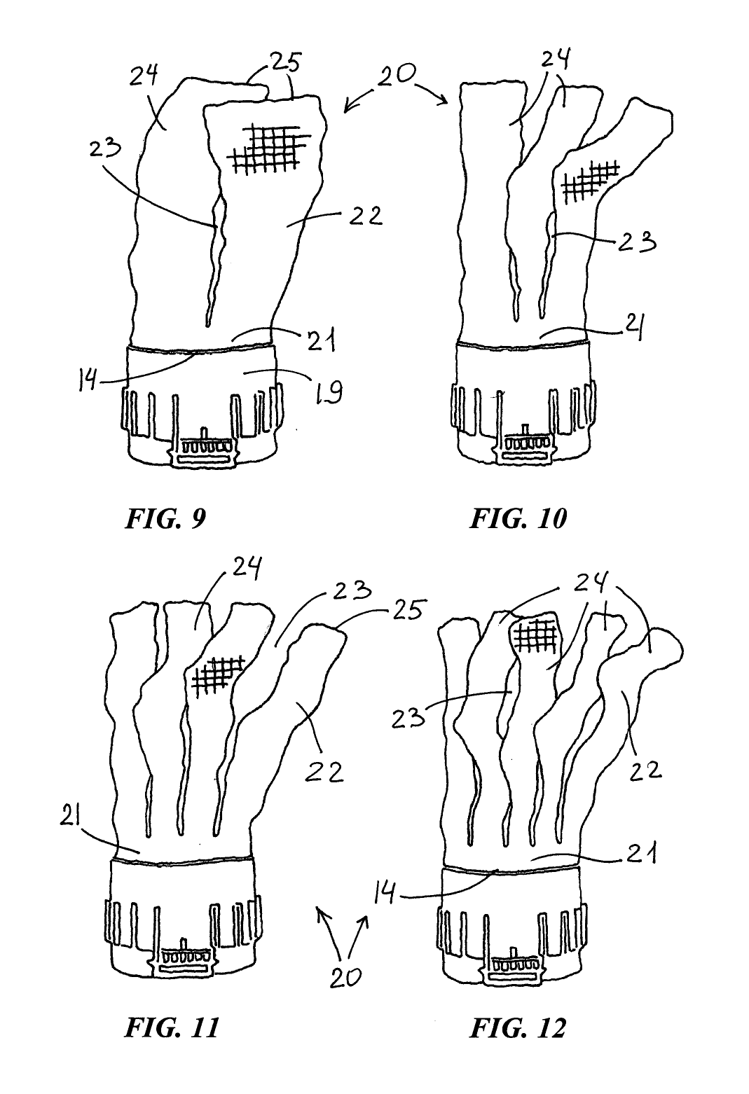

FIGS. 8-12 show examples of free-end portion 22 including a plurality of discontinuities 23. These FIGURES show free-end portion 22 formed by a plurality of strips 24 extending from proximal-end portion 21 to free ends 25. As illustrated in FIGS. 9-12, strips 24 are separated from one another when restrictor 20 is substantially erect. FIG. 8 schematically illustrates how restrictor 20 relieves resistance to the incoming flow of liquid by the separation along discontinuities 23. FIG. 9 shows free-end portion 22 including two discontinuities 23 and being formed by two strips 24. FIG. 10 shows free-end portion 22 including three discontinuities 23 and being formed by three strips 24. FIG. 11 shows free-end portion 22 including at least four discontinuities 23 and including four strips 24. FIG. 12 shows free-end portion 22 having five discontinuities 23 and including five strips 24.

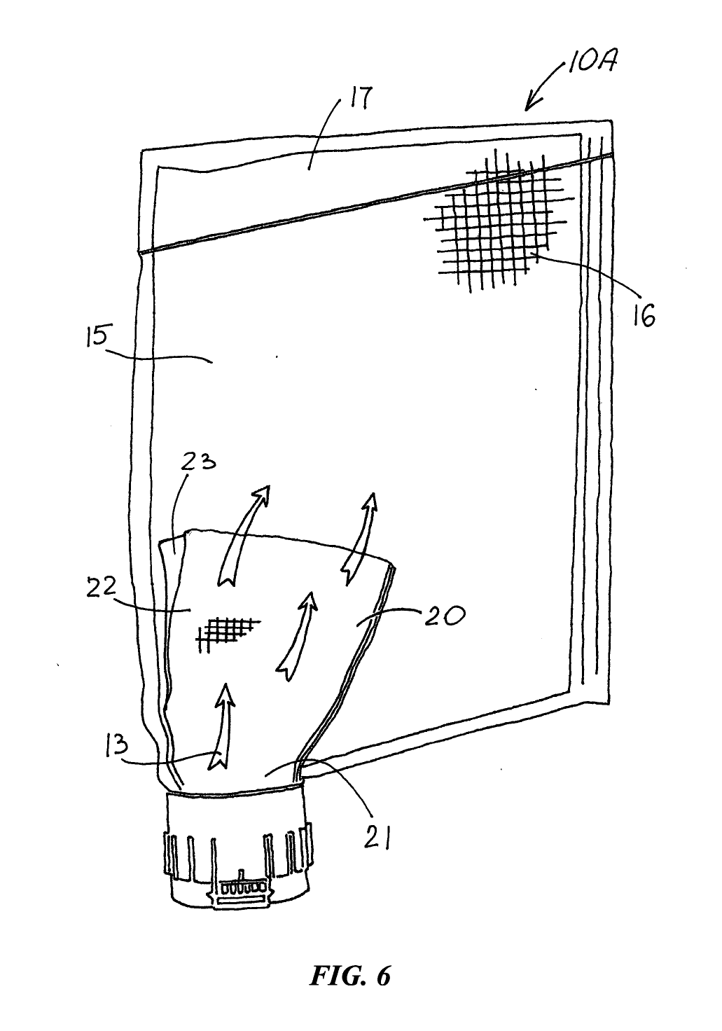

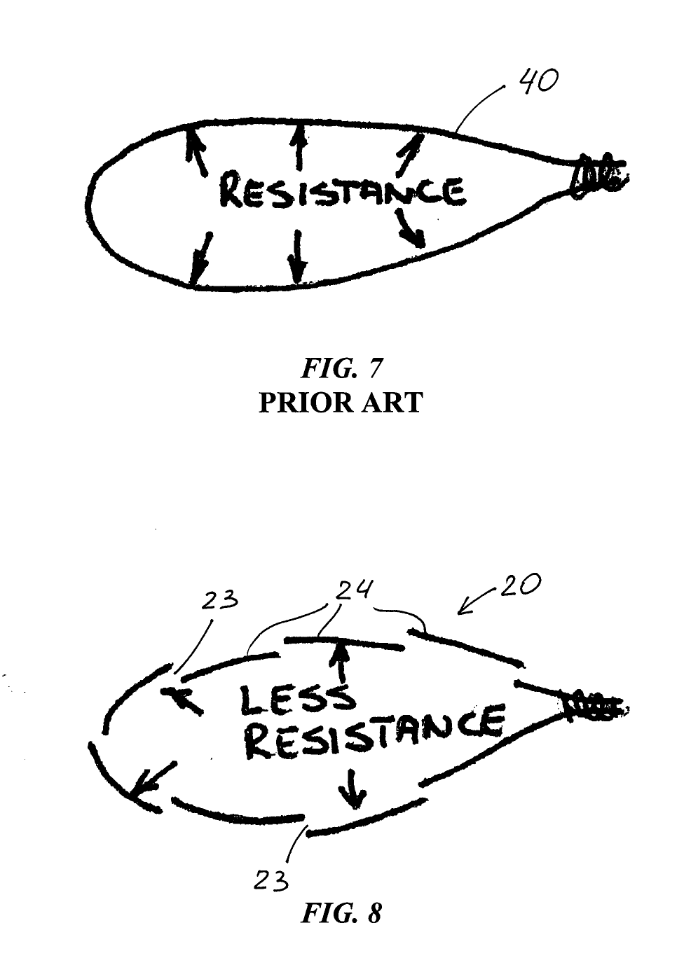

FIGS. 3, 6 and 9-13 show proximal-end portion 21 substantially free of discontinuities 23. FIG. 3 shows free-end portion 22 being about half the length of restrictor 20. In FIG. 6, free-end portion 22 is shown greater than half the length of restrictor 20. FIGS. 9-12 show free-end portion 22 greater than about two-thirds the length of restrictor 20.

FIGS. 9-12 best show restrictor 20 as a single piece with proximal-end portion 21 and free-end portion 22 being integrally formed. FIG. 3 best illustrates restrictor 20 formed by a slit tube. Such tube may be of a fluid-pervious material.

While the principles of this invention have been described in connection with specific embodiments, it should be understood clearly that these descriptions are made only by way of example and are not intended to limit the scope of the invention.

1. In debris-capturing apparatus for a cleaner device having an outflow port through which debris-laden fluid flows, the debris-capturing apparatus having an entry annulus and a debris cavity to receive flow of debris-laden fluid, the improvement comprising a collapsible elongate back-flow restrictor which is substantially erect in the flow direction during inflow and has an annular proximal-end portion secured about the entry annulus and a free-end portion within the debris cavity, the free-end portion having at least one discontinuity along the length thereof to relieve resistance to debris-laden fluid flow into the cavity and to facilitate collapse of the restrictor for back-flow restriction.

2. The debris-capturing apparatus of claim 1 wherein:
the debris cavity is defined by a wall of a fluid-pervious material; and
the entry annulus is configured for securement to the outflow port.

3. The debris-capturing apparatus of claim 1 wherein the free-end portion includes a plurality of discontinuities.

4. The debris-capturing apparatus of claim 3 wherein the free-end portion is formed by a plurality of strips extending from the proximal-end portion to free ends, the strips being separated from one another when the restrictor is substantially erect.

5. The debris-capturing apparatus of claim 4 wherein the free-end portion includes two discontinuities and is formed by two strips.

6. The debris-capturing apparatus of claim 1 wherein the proximal-end portion is substantially free of discontinuities.

7. The debris-capturing apparatus of claim 6 wherein the free-end portion is greater than half the length of the restrictor.

8. The debris-capturing apparatus of claim 7 wherein the free-end portion is greater than about two-thirds the length of the restrictor.

9. The debris-capturing apparatus of claim 8 wherein the free-end portion includes a plurality of discontinuities.

10. The debris-capturing apparatus of claim 9 wherein the free-end portion is formed by a plurality of strips extending from the proximal-end portion to free ends, the strips being separated from one another when the restrictor is substantially erect.

11. The debris-capturing apparatus of claim 10 wherein the free-end portion includes two discontinuities and is formed by two strips.

12. The debris-capturing apparatus of claim 1 wherein the restrictor is a single piece with the proximal-end portion and the free-end portion being integrally formed.

13. The debris-capturing apparatus of claim 12 wherein the restrictor is formed by a slit tube.

14. The debris-capturing apparatus of claim 13 wherein the tube is of a fluid-pervious material.
